(19) United States
(12) Patent Application Publication
(10) Pub. No.: US 2016/0017554 A1
(43) Pub. Date: Jan. 21, 2016

(54) SYSTEM FOR THE AUTOMATIC DEPLOYMENT OF TRAFFIC CONTROL SIGNS DURING A POWER OUTAGE

(71) Applicant: Jeff Snyder, Clermont, FL (US)

(72) Inventor: Jeff Snyder, Clermont, FL (US)

(21) Appl. No.: 14/754,317

(22) Filed: Jun. 29, 2015

Related U.S. Application Data
(60) Provisional application No. 62/026,421, filed on Jul. 18, 2014.

(51) Int. Cl. E01F 9/04; G09F 7/00

(52) U.S. Cl. CPC E01F 9/045; G09F 7/002

(57) ABSTRACT

A system for the automatic deployment of traffic control signs during a power outage which enhances public safety, automatically deploys in the event of power outage, can be placed in a plurality of roadway intersections and structures, provides an alternative means to deploy safety and other information, and eliminates driver confusion when deployed. The system essentially comprises a traffic control sign that is bisected and having a top half portion and a bottom half portion connected by a hinge means, an electromagnet attached to the approximate center of the top half portion front surface, an armature plate attached to the bottom half portion front surface, an attaching means attached to the top half portion back surface for affixing the system to a structure in an environment, and at least one power cable extending from the electromagnet and connecting to a powering means in the environment. This system is believed to be useful in a variety of environments and by agencies such as municipal, state and federal departments of transportation.

### CROSS-REFERENCE TO RELATED APPLICATIONS

This application claims the benefit of U.S. Provisional Application No. 62/026,421, filing date Jul. 18, 2014.

### TECHNICAL FIELD

This invention relates generally to signs. More specifically this invention relates to traffic control signs.

### BACKGROUND OF THE INVENTION

Traffic can become quite hectic and unsafe when power outages occur due to storms, inclement weather, malfunctions and the like. When for example thunderstorms cause traffic lights to become inoperable, the rates of serious accidents and injuries increase significantly. In the current art and in order to reduce accidents, intersections that become inoperable are maintained by a traffic controller or police officers. However, their response is not always possible and certainly never instantaneous upon the loss of power. Therefore, there is a need for a system that can be implemented concomitantly with existing traffic lights which automatically deploy and display safety information in the event of a power outage.

In the current art, there exist some devices that act as emergency backup systems for traffic light power failures. These devices generally employ secondary powering means such as battery packs. However, these devices run out of power, stop working, require recharging and are relatively expensive.

Therefore, in the applicant's experience, there is a need for a new and useful system for the automatic deployment of traffic control signs during a power outage which possesses the properties of i) enhancing public safety, ii) automatic deployment in the event of power outage, iii) ability to be placed in a plurality of roadway intersections and structures, iv) providing an alternative means to deploy safety and other information, and v) eliminating driver confusion when deployed. The device of the present invention is believed to accomplish all of the foregoing objectives.

### SUMMARY OF THE INVENTION

The present invention provides a new and useful system for the automatic deployment of traffic control signs during a power outage which enhances public safety, automatically deploys in the event of power outage, can be placed in a plurality of roadway intersections and structures, provides an alternative means to deploy safety and other information, and eliminates driver confusion when deployed. This system is believed to be useful in a variety of environments and by agencies such as municipal, state and federal departments of transportation.

In one of its basic embodiments, the system comprises a traffic control sign that is horizontally bisected and has a top half portion and a bottom half portion connected by a hinge means, an electromagnet attached to the approximate center of the front surface of the top half portion, an armature plate attached to the front surface of the bottom half portion, an attaching means attached to the top half portion back surface for affixing the system to a structure in an environment, and at least one power cable extending from the electromagnet and connecting to a powering means in the environment.

When the device is in use, device comprises a hinged bisected sign which attached to a structure in the environment, such as a traffic light signal pole. The device is held shut in a closed configuration by an electromagnet. An electromagnet is a type of magnet in which a magnetic field is produced by an electric current. This electromagnet holds both halves of the sign together as long as current is running to the electromagnet. When the system is in a closed configuration no traffic sign information is displayed to the travelers nearby.

In the event of power failure, current ceases to flow to the electromagnet, the magnetic field therefore dissipates and the folded sign deploys by relying on gravity to pull the halves apart. Once deployed to an open configuration, emergency and safety information on the previously obscured surface is now visible to the onlooker.

One envisioned implementation of the present invention is for use at four way intersections which have electric traffic lights. The current invention would exist alongside the existing electric traffic lights, and be powered by a common source. In the event of a power outage whereby the electric traffic lights cease to function, the system would automatically deploy into an open configuration. Each system would display an octagonal stop sign for each direction of traffic and thereby transform the intersection into a four way stop, eliminate driver confusion, and increase safety. Once the power has been restored, the system can be manually or mechanically returned to the closed configuration with electromagnet holding the halves of the sign together.

It is envisioned that the system can be utilized in any area where it is favorable for information to be disseminated upon power failure. It is also envisioned that the information need not only be limited to but at least include traffic, regulatory, warning, marker, guide or informational signs.

Thus the present invention provides a new and useful system for the automatic deployment of traffic control signs during a power outage which has the properties of i) enhancing public safety, ii) automatic deployment in the event of power outage, iii) ability to be placed in a plurality of roadway intersections and structures, iv) providing an alternative means to deploy safety and other information, and v) eliminating driver confusion when deployed. The device of the present invention is believed to accomplish all of the foregoing objectives. Further features and objectives of the present invention will become apparent form the following detailed description and the accompanying drawings.

### BRIEF DESCRIPTION OF THE DRAWINGS

FIG. 1 is a front elevation view of a system for the automatic deployment of traffic control signs during a power outage in a deployed configuration according to the present invention;

FIG. 2 is a perspective view of a system for the automatic deployment of traffic control signs during a power outage being deployed from a closed configuration;

FIG. 3 is a rear perspective view of a system for the automatic deployment of traffic control signs during a power outage in a deployed configuration according to the present invention;

FIG. 4 is a side elevation view of an alternate embodiment of the present invention wherein the attaching means are bolts;

FIG. 5 is a front elevation view of an alternate embodiment of the present invention; and

FIG. 6 is a front elevation view of a system for the automatic deployment of traffic control signs during a power outage in a deployed configuration and attached to a traffic light signal pole in the environment.

### DETAILED DESCRIPTION OF THE INVENTION

As described above, the present invention provides a new and useful system for the automatic deployment of traffic control signs during a power outage which enhances public safety, automatically deploys in the event of power outage, can be placed in a plurality of roadway intersections and structures, provides an alternative means to deploy safety and other information, and eliminates driver confusion when deployed. This system is believed to be useful in a variety of environments and by agencies such as municipal, state and federal departments of transportation. The following description and accompanying drawings disclose at least one version of the device.

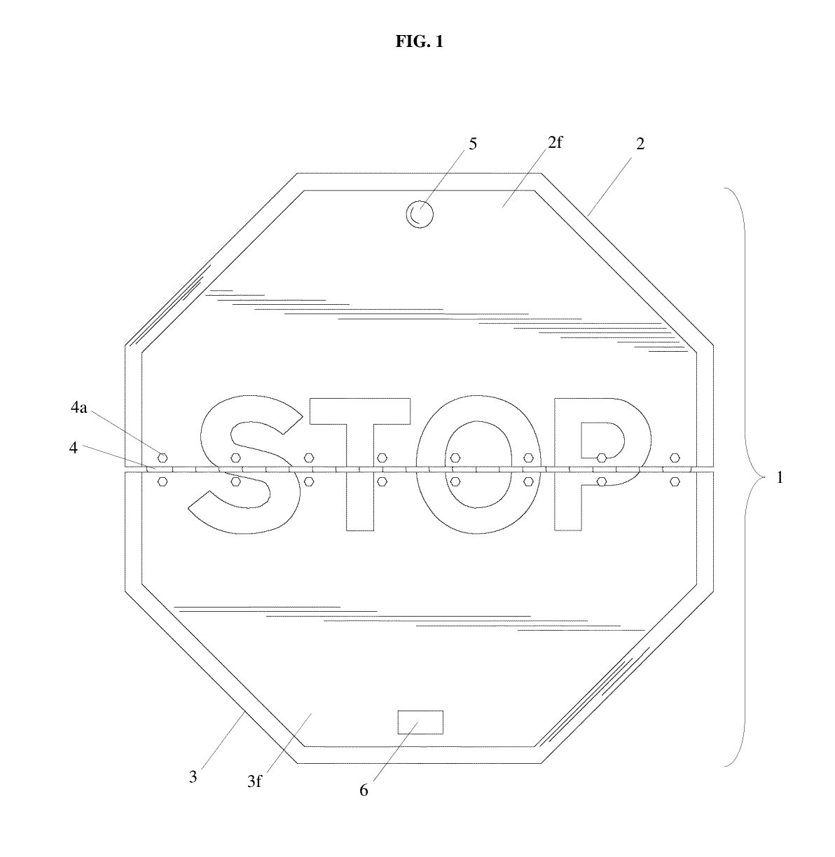

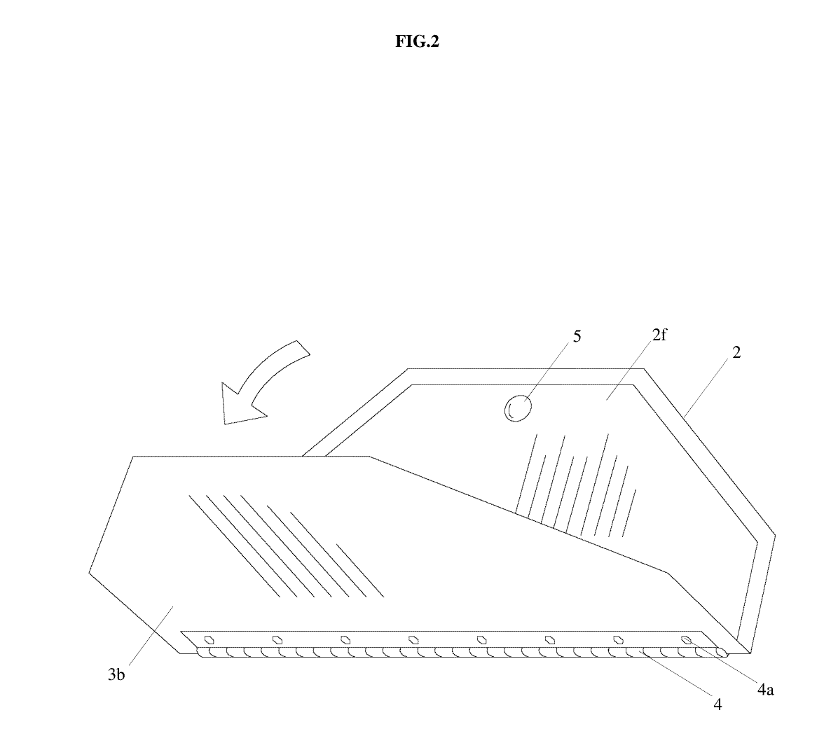

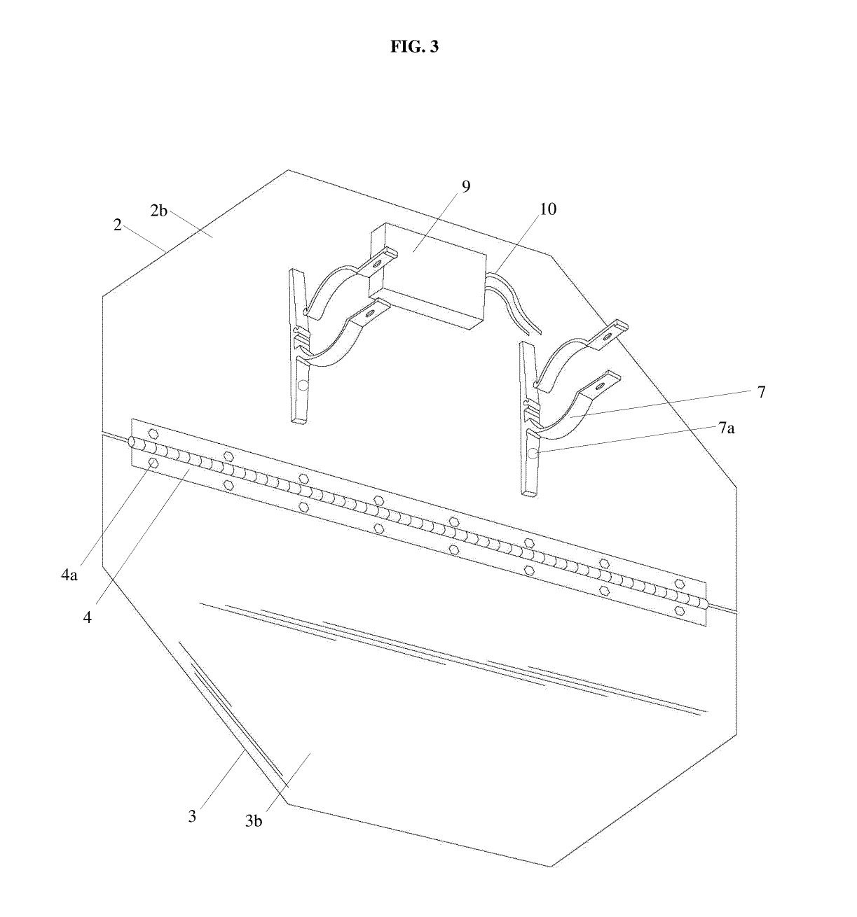

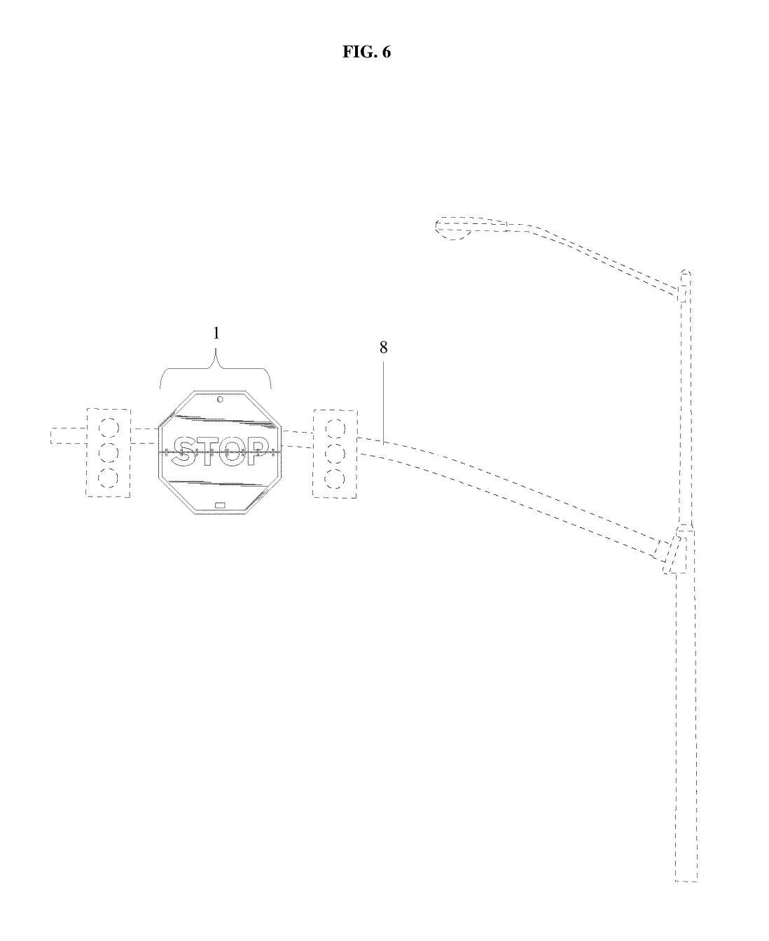

Referring now to FIG. 1 to FIG. 3 and FIG. 6 there is shown a system for the automatic deployment of traffic control signs during a power outage which comprises a hexagonal stop sign 1 that is bisected horizontally and having a top half portion 2 and a bottom half portion 3 wherein said top half portion 2 has a top half portion front surface 2f and a top half portion back surface 2b, and the bottom half portion 3 has a bottom half portion front surface 3f and a bottom half portion back surface 3b. A piano hinge 4 is connected in a generally horizontal orientation between and to the top half portion 2 and the bottom half portion 3 of the stop sign 1, thereby allowing the top half portion 2 and bottom half portion 3 to rotationally swing about a central axis of the piano hinge 4. The piano hinge 4 has an interior opening angle range of at least 0 to 180 degrees thereby allowing the system to variably present in a closed configuration with interior opening angle of approximately 0 degrees and a deployed configuration with interior opening angle of approximately 180 degrees.

In further detail and still referring to FIG. 1 to FIG. 3 and FIG. 6, an electromagnet 5 is attached to the approximate center of a top edge of the top half portion front surface 2f. An armature plate 6 is attached to the approximate center of a bottom edge of the of the bottom half portion front surface 3f. The armature plate 6 of the bottom half portion front surface 3f aligns with and contacts the electromagnet 5 of the top half portion front surface 2f when the system is in a closed configuration—in essence folded in half. At least one pole clamp 7 is attached to the top half portion back surface 2b for affixing the system to a structure 8 in an environment, such as a traffic light pole. A weather impermeable electronics housing 9 is attached to the top half portion back surface 2b wherein electronic components relating to the electromagnet 5 and system are housed within an interior void. At least one power cable 10 extends from the electronics housing 9 and connects to a powering means in the environment.

In at least one alternative embodiment of the present invention, the piano hinge 4 is attached to the top half portion 2 and the bottom half portion 3 by a piano hinge attaching means 4a which is at least one bolt, rivets, weld or adhesive.

In at least one alternative embodiment of the present invention, the pole clamp 7 is attached to the top half portion 2 by a pole clamp attaching means 7a which is at least one bolt, rivets, weld or adhesive.

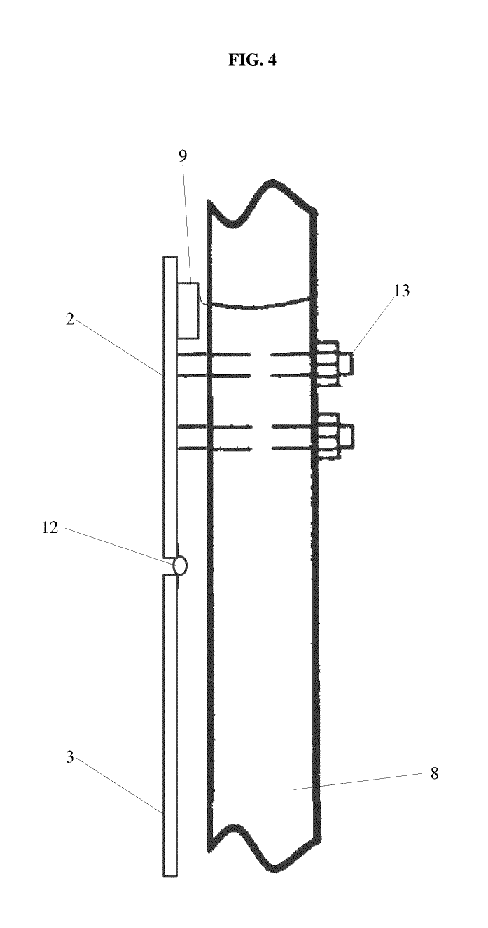

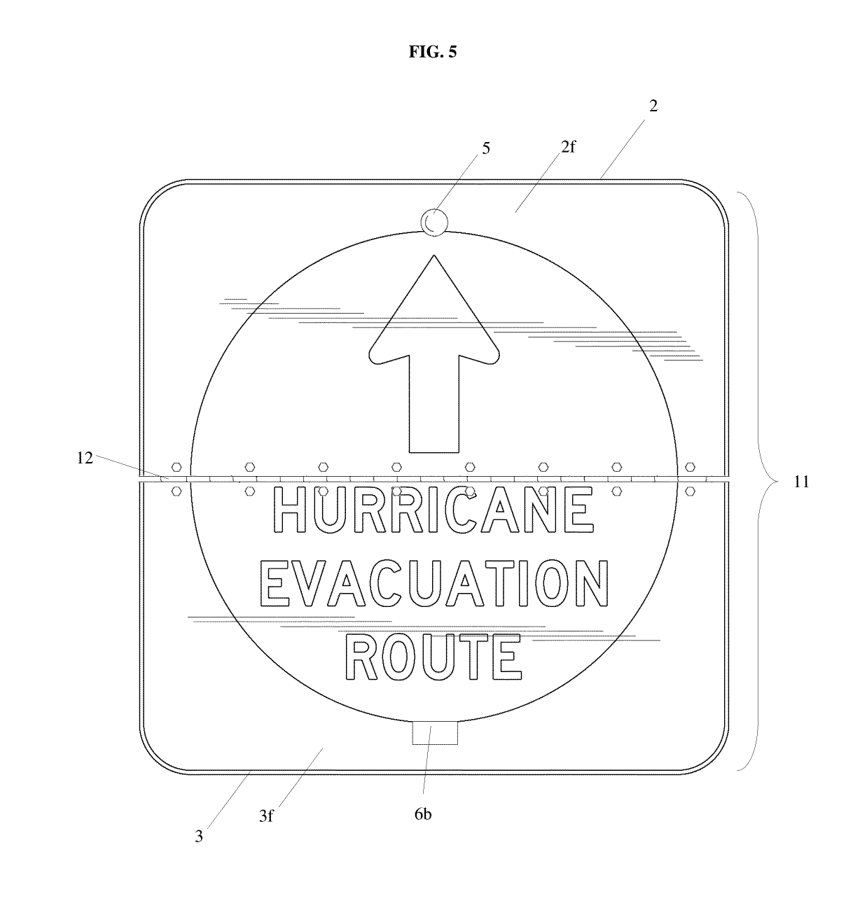

Referring now to FIG. 4 and FIG. 5, in an alternate embodiment of the present invention, the system comprises a traffic control sign 11 that is bisected and having a top half portion 2 and a bottom half portion 3. The top half portion 2 has a top half portion front surface 2f and a top half portion back surface 2b. The bottom half portion 3 has a bottom half portion front surface 3f and a bottom half portion back surface 3b. A hinge means 12 is located between the top half portion 2 and the bottom half portion 3, where the hinge means 12 is at least one barrel hinge, a piano hinge, a material crease, rings, links, or flexible straps. An electromagnet 5 is attached to the approximate center of a top edge of the top half portion front surface 2f.

In more detail and still referring to FIG. 4 and FIG. 5, the system further comprises an attaching means 13 attached to the top half portion back surface 2b for affixing the system to a structure 8 in an environment. The attaching means 13 is at least one pole bracket, adhesive, straps, bolts, clamps, u bracket, or adjustable clamp. At least one power cable 10 extends from the electromagnet 5 and connects to a powering means in the environment.

In at least one alternative embodiment, the system further comprises an armature plate 6 is attached to the approximate center of a bottom edge of the bottom half portion front surface 3f, where the armature plate 6 of the bottom half portion front surface 3f aligns with and contacts the electromagnet 5 of the top half portion front surface 2f when the system is in a closed configuration.

In at least one alternative embodiment, the system further comprises an informational design printed on the top half portion front surface 2f and bottom half portion front surface 3f.

In at least one alternative embodiment, the system further comprises an armature plate 6 attached to the approximate center of a bottom edge of the bottom half portion front surface 3f, wherein the armature plate 6 of the bottom half portion front surface 3f aligns with and contacts the electromagnet 5 of the top half portion front surface 2f when the system is in a closed configuration. The system may also comprise a weather impermeable electronics housing 9 attached to the top half portion back surface 2b wherein electronic components relating to the electromagnet 5 and system are housed within an interior void.

In at least one embodiment of the present invention, the attaching means 13 is oriented to attach the system to a horizontal traffic signal pole. While in another embodiment the attaching means 13 is oriented to attach the system to a vertical traffic signal pole. In the alternative embodiment, the attaching means 13 further comprises a plurality of adjustable joints for permanently fixing the system at variable angles to a structure 8 in the surrounding environment.

In at least one alternative embodiment of the present invention, the invention further comprises a motor, wherein the motor allows for the purposeful deployment of the system or return of the system to a closed configuration.

In at least one alternative embodiment of the present invention, an informational design is printed on the bottom half portion back surface 3b for the display of information when the system is in a closed configuration. Thereby a street name or other information is displayed on the bottom half portion back surface which is visible to an observer when the system is in a closed configuration.

In an alternate embodiment of the present invention, the system further comprises a circuit which is essentially a switch for the selective reversal of polarity of the electromagnet thereby creating a forcible deployment of the system using magnetic repulsion forces.

In at least one alternate embodiment of the present invention, the system further comprises a permanent magnet 6b attached to the approximate center of a bottom edge of the of the bottom half portion front surface 3f, where the permanent magnet 6b of the bottom half portion front surface 3f aligns with and contacts the electromagnet 5 of the top half portion front surface 2f when the system is in a closed configuration.

The previously described versions of the present invention have many advantages including and without limitation, the properties of i) enhancing public safety, ii) automatic deployment in the event of power outage, iii) ability to be placed in a plurality of roadway intersections and structures, iv) providing an alternative means to deploy safety and other information, and v) eliminating driver confusion when deployed. The device of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A system for the automatic deployment of traffic control signs during a power outage which comprises:
a) a hexagonal stop sign that is bisected horizontally and having a top half portion and a bottom half portion,
said top half portion having a top half portion front surface and a top half portion back surface, said bottom half portion having a bottom half portion front surface and a bottom half portion back surface;
b) a piano hinge connected in a generally horizontal orientation between and to the top half portion and the bottom half portion of the stop sign, thereby allowing the top half portion and bottom half portion to rotationally swing about a central axis of the piano hinge,
said piano hinge having an interior opening angle range of at least 0 to 180 degrees thereby allowing the system to variably present in a closed configuration with interior opening angle of approximately 0 degrees and a deployed configuration with interior opening angle of approximately 180 degrees;
c) an electromagnet attached to the approximate center of a top edge of the top half portion front surface,
d) an armature plate attached to the approximate center of a bottom edge of the of the bottom half portion front surface,
said armature plate of the bottom half portion front surface aligning with and contacting the electromagnet of the top half portion front surface when the system is in a closed configuration;
e) at least one pole clamp attached to the top half portion back surface for affixing the system to a structure in an environment;
f) a weather impermeable electronics housing attached to the top half portion back surface wherein electronic components relating to the electromagnet and system are housed within an interior void; and
g) at least one power cable extending from the electronics housing and connecting to a powering means in the environment.

2. A system for the automatic deployment of traffic control signs during a power outage which comprises:
a) a traffic control sign that is bisected and having a top half portion and a bottom half portion,
said top half portion having a top half portion front surface and a top half portion back surface, said bottom half portion having a bottom half portion front surface and a bottom half portion back surface;
b) a hinge means located between the top half portion and the bottom half portion,
said hinge means is at least one barrel hinge, a piano hinge, a material crease, rings, links, or flexible straps;
c) an electromagnet attached to the approximate center of a top edge of the top half portion front surface,
d) an attaching means attached to the top half portion back surface for affixing the system to a structure in an environment,
said attaching means is at least one pole bracket, adhesive, straps, bolts, clamps, u bracket, or adjustable clamp; and
e) at least one power cable extending from the electromagnet and connecting to a powering means in the environment.

3. The system as in claim 1 wherein the piano hinge is attached to the top half portion and the bottom half portion by a piano hinge attaching means which is at least one bolt, rivets, weld or adhesive.

4. The system as in claim 1 wherein the pole clamp is attached to the top half portion by a pole clamp attaching means which is at least one bolt, rivets, weld or adhesive.

5. The system as in claim 1 further comprising a motor, wherein said motor allows for the purposeful deployment of the system or return of the system to a closed configuration.

6. The system as in claim 1 further comprising an informational design printed on the bottom half portion back surface for the display of information when the system is in a closed configuration.

7. The system as in claim 1 further comprising a circuit which is essentially a switch for the selective reversal of polarity of the electromagnet thereby creating a forcible deployment of the system using magnetic repulsion forces.

8. The system as in claim 2 further comprising an informational design printed on the top half portion front surface and bottom half portion front surface.

9. The system as in claim 2 further comprising an armature plate attached to the approximate center of a bottom edge of the bottom half portion front surface, wherein said armature plate of the bottom half portion front surface aligns with and contacts the electromagnet of the top half portion front surface when the system is in a closed configuration.

10. The system as in claim 2 further comprising a weather impermeable electronics housing attached to the top half portion back surface wherein electronic components relating to the electromagnet and system are housed within an interior void.

11. The system as in claim 2 wherein the attaching means is oriented to attach the system to a horizontal traffic signal pole.

12. The system as in claim 2 wherein the attaching means is oriented to attach the system to a vertical traffic signal pole.

13. The system as in claim 2 wherein the attaching means further comprises a plurality of adjustable joints for permanently fixing the system at variable angles to a structure in the surrounding environment.

14. The system as in claim 2 further comprising a motor, wherein said motors allows for the purposeful deployment of the system or return of the system to a closed configuration.

15. The system as in claim 2 further comprising an informational design printed on the bottom half portion back surface for the display of information when the system is in a closed configuration.

16. The system as in claim 2 further comprising a circuit which is essentially a switch for the selective reversal of polarity of the electromagnet thereby creating a forcible deployment of the system using magnetic repulsion forces.

17. The system as in claim 2 further comprising an armature plate attached to the approximate center of a bottom edge of the bottom half portion front surface,
said armature plate of the bottom half portion front surface aligning with and contacting the electromagnet of the top half portion front surface when the system is in a closed configuration.

18. The system as in claim 7 further comprising a permanent magnet attached to the approximate center of a bottom edge of the of the bottom half portion front surface,
said permanent magnet of the bottom half portion front surface aligning with and contacting the electromagnet of the top half portion front surface when the system is in a closed configuration.

19. The system as in claim 16 further comprising a permanent magnet attached to the approximate center of a bottom edge of the of the bottom half portion front surface,
said permanent magnet of the bottom half portion front surface aligning with and contacting the electromagnet of the top half portion front surface when the system is in a closed configuration.
